(19) United States
(12) Patent Application Publication
(10) Pub. No.: US 2026/0304141 A1
(43) Pub. Date: Oct. 1, 2026

(54) RADIO ZONE DESIGN APPARATUS, RADIO ZONE DESIGN METHOD, AND PROGRAM

(71) Applicant: NTT, Inc., Tokyo (JP)

(72) Inventors: Toshiro NAKAHIRA, Tokyo (JP); Daisuke MURAYAMA, Tokyo (JP); So TAKATANI, Tokyo (JP); Takatsune MORIYAMA, Tokyo (JP)

(21) Appl. No.: 19/489,031

(22) PCT Filed: Jun. 6, 2023
(86) PCT No.: PCT/JP2023/021024

§ 371 Date: Dec. 1, 2025

(51) Int. Cl. H04W 16/18

(52) U.S. Cl. CPC H04W 16/18

(57) ABSTRACT

An object of the present disclosure is to perform appropriate radio zone design according to the purpose of use. Therefore, the present disclosure relates to a radio zone design apparatus that performs design related to installation of base stations for wireless communication, the radio zone design apparatus including a selection unit that performs a selection process of selecting, from among candidates for a plurality of wireless communication devices to be installed as the base stations, a predetermined number of top wireless communication devices having both first design values satisfying a first target value and considered when performing the design, and highest second design values considered when performing the design.

### TECHNICAL FIELD

The present disclosure relates to a design technique for installing a base station for wireless communication.

### BACKGROUND ART

Generally, in order to establish a coverage area for wireless communication such as a cellular network or a wireless local area network (LAN), radio zone design is performed to determine the installation positions of base stations and the antenna directions. In the radio zone design, when a simulation evaluation of the coverage area is performed after the placement of a base station is selected, a method such as a ray tracing method (NPL 1) is used.

In addition, in the case of remotely controlling a robot via remote control, communication quality such as radio wave strength is prioritized, whereas in the case of providing an Internet connection environment for users in a cafe, store, etc., it is conceivable that cost is prioritized. Therefore, there is a need to select the type of wireless communication device to be installed as a base station and perform radio zone design according to the purpose of use.

### CITATION LIST

### Non-Patent Literature

[NPL 1] NTT DoComo Technical Journal vol. 15 no. 3 <https://www.nttdocomo.co.jp/binary/pdf/corporate/technology/rd/technical_journal/bn/vol15_3/vol15_3_020jp.pdf>

### SUMMARY OF INVENTION

### Technical Problem

However, with the related art as shown in NPL 1, it is difficult to perform appropriate radio zone design according to the purpose of use.

The present invention has been made in consideration of the above-mentioned points, and an object of the present invention is to perform appropriate radio zone design according to the purpose of use.

### Solution to Problem

In order to solve the above problem, the invention according to claim 1 relates to a radio zone design apparatus that performs design related to installation of base stations for wireless communication, the radio zone design apparatus including a selection unit that performs a selection process of selecting, from among candidates for a plurality of wireless communication devices to be installed as the base stations, a predetermined number of top wireless communication devices having both first design values satisfying a first target value and considered when performing the design, and highest second design values considered when performing the design.

### Advantageous Effects of Invention

As described above, according to the present invention, it is possible to provide an effect that appropriate radio zone design can be performed according to the purpose of use.

### BRIEF DESCRIPTION OF DRAWINGS

FIG. 1 is an overall configuration diagram of a communication system according to an embodiment.

FIG. 2 is an electrical hardware configuration diagram of a radio zone design apparatus according to the embodiment.

FIG. 3 is an electrical hardware configuration diagram of a communication terminal according to the embodiment.

FIG. 4 is a functional configuration diagram of the radio zone design apparatus according to the embodiment.

FIG. 5 is a conceptual diagram of a radio zone design target area.

FIG. 6 is a flowchart illustrating a radio zone design method executed by the radio zone design apparatus according to the embodiment.

FIG. 7 is a flowchart illustrating a radio zone design method executed by the radio zone design apparatus according to the embodiment.

### DESCRIPTION OF EMBODIMENTS

Hereinafter, embodiments of the present invention will be described with reference to the drawings.

### [System Configuration of Embodiment]

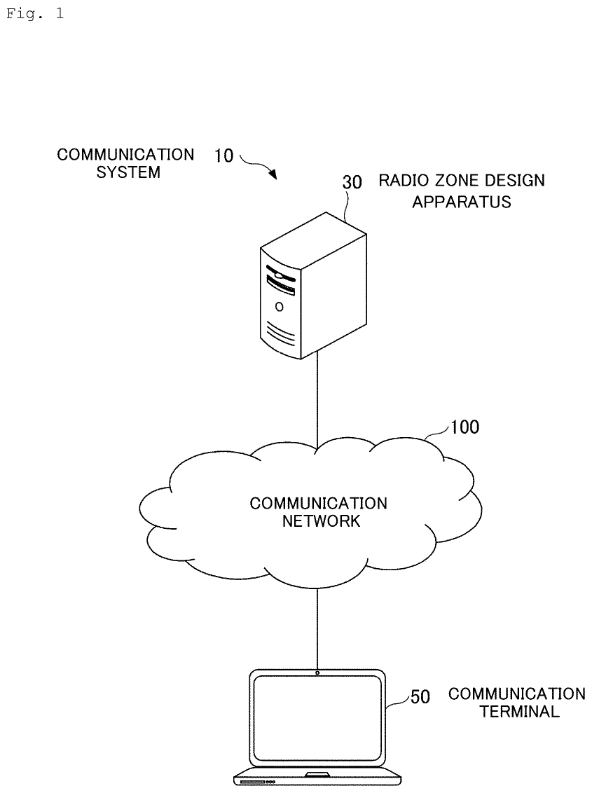

First, an overall configuration of a communication system according to an embodiment will be described with reference to FIG. 1. FIG. 1 is an overall configuration diagram of the communication system according to the present embodiment.

As illustrated in FIG. 1, a communication system 10 according to the present embodiment is constructed by a radio zone design apparatus 30 and a communication terminal 50. The communication terminal 50 is managed and used by a user. The user is a person who references an output result of the radio zone design apparatus 30 and determines what to do next.

The radio zone design apparatus 30 and the communication terminal 50 can communicate with each other through a communication network 100 such as the Internet. The connection form of the communication network 100 may be either wireless or wired.

The radio zone design apparatus 30 is composed of one or more computers. When the radio zone design apparatus 30 is composed of a plurality of computers, it may be indicated as a “radio zone design apparatus” or as a “radio zone design system.” The radio zone design apparatus 30 is a device that performs design related to installation of base stations for wireless communication, and performs more appropriate radio zone design by selecting an appropriate wireless communication device from among candidates for wireless communication devices to be installed as base stations (such as 5G antennas or Wi-Fi access points (APs)) according to the purpose of use.

The communication terminal 50 is a computer, and in FIG. 1, a laptop personal computer is illustrated as an example. In FIG. 1, a user operates the communication terminal 50. Note that the radio zone design apparatus 30 may perform processing alone without using the communication terminal 50.

### [Hardware Configuration]

### <Hardware Configuration of Radio Zone Design Apparatus>

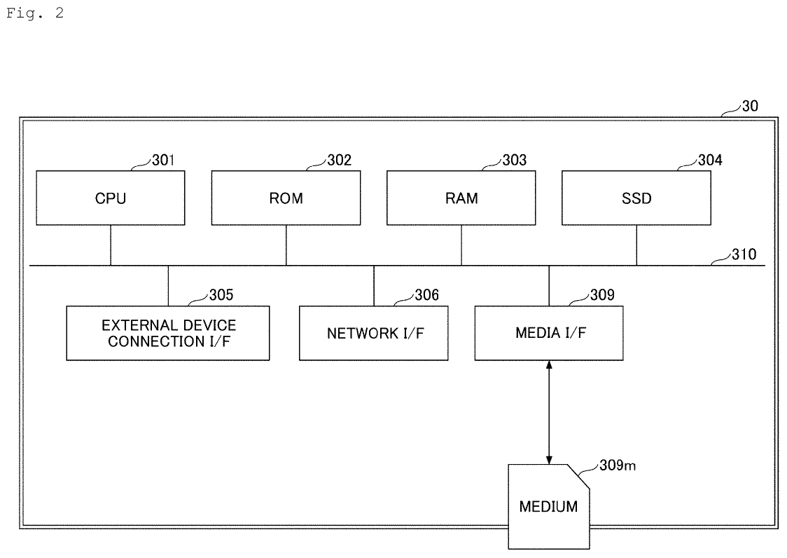

Next, an electrical hardware configuration of the radio zone design apparatus 30 will be described with reference to FIG. 2. FIG. 2 is an electrical hardware configuration diagram of the radio zone design apparatus.

The radio zone design apparatus 30 is a computer, and includes a central processing unit (CPU) 301 as a processor, a read only memory (ROM) 302, a random access memory (RAM) 303, a solid state drive (SSD) 304, an external device connection interface (I/F) 305, a network I/F 306, a media I/F 309, and a bus line 310, as illustrated in FIG. 2.

Among these, the CPU 301 controls the overall operation of the radio zone design apparatus 30. The ROM 302 stores a program used for driving the CPU 301 such as an initial program loader (IPL). The RAM 303 is used as a work area of the CPU 301.

The SSD 304 reads out or writes various types of data under the control of the CPU 301. Note that a hard disk drive (HDD) may be used instead of the SSD 304.

The external device connection I/F 305 is an interface for connecting various types of external devices. In this case, the external devices are a display, a speaker, a keyboard, a mouse, a Universal Serial Bus (USB) memory, a printer, and the like.

The network I/F 306 is an interface for data communication performed via the communication network 100.

The media I/F 309 controls reading or writing (storing) of data from or into a recording medium 309m such as a flash memory. The recording medium 309m also includes a digital versatile disc (DVD), a Blu-ray disc (registered trademark), and the like.

The bus line 310 is an address bus, a data bus, or the like for electrically connecting each of the components such as the CPU 301 illustrated in FIG. 2.

### <Hardware Configuration of Communication Terminal>

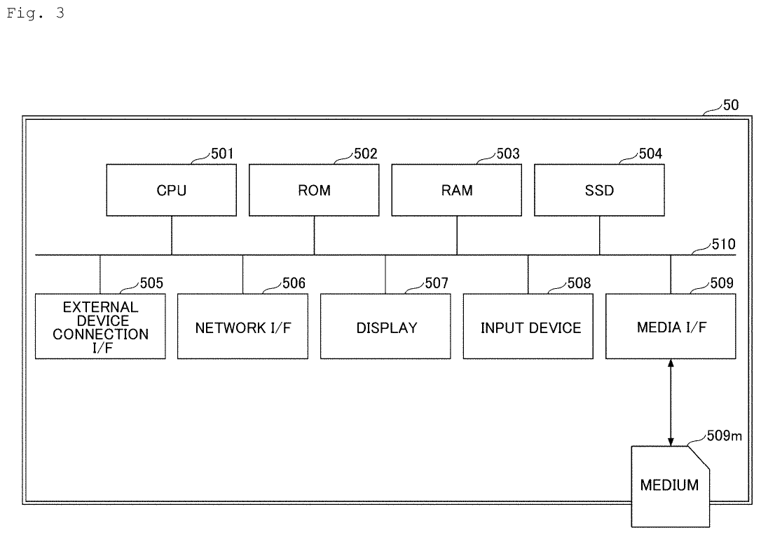

An electrical hardware configuration of the communication terminal 50 will be described below with reference to FIG. 3. FIG. 3 is an electrical hardware configuration diagram of the communication terminal.

As illustrated in FIG. 3, the communication terminal 50 functions as a computer and includes a CPU 501, a ROM 502, a RAM 503, an SSD 504, an external device connection interface (I/F) 505, a network I/F 506, a display 507, an input device 508, a media I/F 509, and a bus line 510.

Among these, the CPU 501 controls the entire operation of the communication terminal 50. The ROM 502 stores programs used for driving the CPU 501 such as an IPL. The RAM 503 is used as a work area for the CPU 501.

The SSD 504 reads and writes various types of data under the control of the CPU 501. Note that, instead of the SSD 504, a hard disk drive (HDD) may be used.

The external device connection I/F 505 is an interface for connecting various types of external devices. The external devices in this case are a display, a speaker, a keyboard, a mouse, a USB memory, a printer, and the like.

The network I/F 506 is an interface for data communication via the communication network 100.

The display 507 is a type of display means such as a liquid crystal or an organic electroluminescent (EL) display which displays various images.

The input device 508 is a keyboard, a pointing device, or the like and is a type of input part for selecting and executing various instructions, selecting a processing target, moving a cursor, and the like. Note that if the user uses a keyboard, the pointing device function may be turned off.

The media I/F 509 controls reading and writing (storing) of data from and to a recording medium 509m such as a flash memory. The recording medium 509m includes DVDs and Blu-ray discs (registered trademark).

The bus line 510 is an address bus, a data bus, or the like for electrically connecting each of the components such as the CPU 501 illustrated in FIG. 3.

### [Functional Configuration of Embodiment]

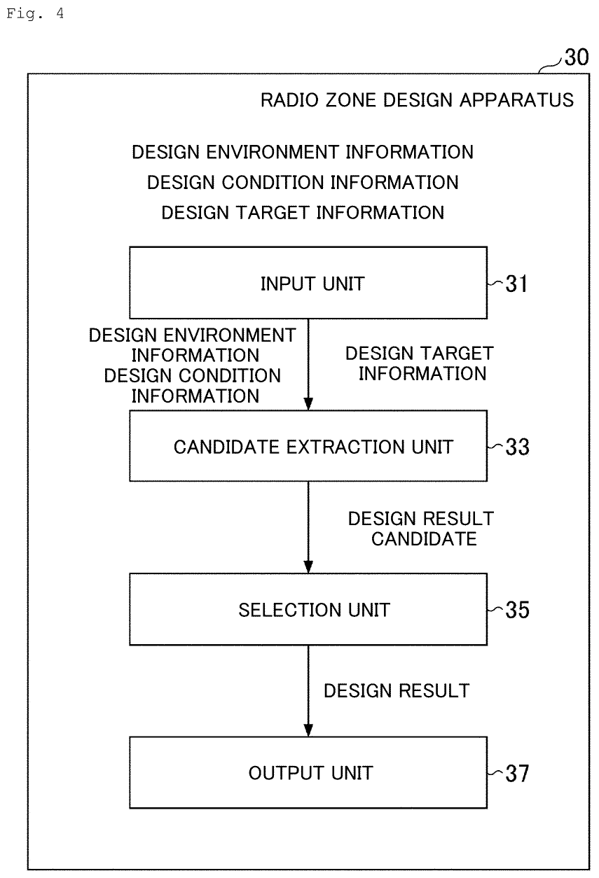

FIG. 4 is a functional configuration diagram of the radio zone design apparatus according to the embodiment.

As illustrated in FIG. 4, the radio zone design apparatus 30 includes an input unit 31, a candidate extraction unit 33, a selection unit 35, and an output unit 37. These respective units are functions implemented by instructions from the CPU 301 of FIG. 2 based on a program.

### <Input Unit>

The input unit 31 inputs design environment information, design condition information, and design target information from the communication terminal 50.

The “design environment information” includes information indicating the size of a radio zone design target area, the size and position of structures, whether or not they are obstructed, a 3D map of the area, and the like.

The “design condition information” includes information indicating the type of wireless communication method (5G, Wi-Fi, etc.) to be installed as a base station, the number of base stations that can be installed (inventory number, etc.), positions (installation position candidates for base stations) and directions in which base stations can be installed within the radio zone design target area, an evaluation position for communication quality (radio wave strength) within the radio zone design target area, a design derivation mode, and the like. In the present embodiment, the “wireless communication method” may be simply referred to as a “communication method.”

The “design derivation mode” includes a cost priority mode, a communication quality priority mode, and a cost and communication quality compatibility mode, and are pre-set according to the purpose of use of a wireless communication device in each radio zone design target area. For example, a cost priority mode is set for areas in an office where PCs and the like are operated, a communication quality priority mode is set for areas where robots are remotely operated via remote control, and a compatibility mode is set for areas even in an office where robots are remotely operated. The radio zone design target area indicates, for example, one floor of a building, a location section of an outdoor exhibition hall, or the like. Also, for example, one floor may be divided into a plurality of areas, and a different mode may be set for each area.

The “design target information” includes communication quality such as radio wave strength (also called “received power”) and device cost for each type of wireless communication device (5G, Wi-Fi, etc.). The device cost is the unit price of the wireless communication device, but may also include the installation cost of the wireless communication device.

Furthermore, the “design target information” includes information indicating target values when performing radio zone design (a target value for communication quality such as radio wave strength and a target value for device cost), priorities when calculating using communication quality and device cost, and the like. For example, when the communication method is 5G, the target value for radio wave strength (RSRP: reference signal received power) is “−105 dBm” and the target value for the device cost is “10 million yen.” Furthermore, when the communication method is Wi-Fi, the target value for radio wave strength (RSSI: received signal strength indicator) is “−75 dBm,” and the target value for device cost is “1 million yen.”

The design environment information, the design condition information, and the design target information may include information other than the above examples. For example, the design target information may include the operating cost (power consumption, etc.) of the device and a target value for this operating cost in addition to or in place of the device cost.

### <Candidate Extraction Unit>

The candidate extraction unit 33 calculates, based on the design environment information and design condition information acquired from the input unit 31, the level of communication quality that will be achieved when a wireless communication device is installed at a specific installation position candidate within the radio zone design target area, thereby calculating a plurality of (i=1, 2, . . . , I) radio zone design result candidates.

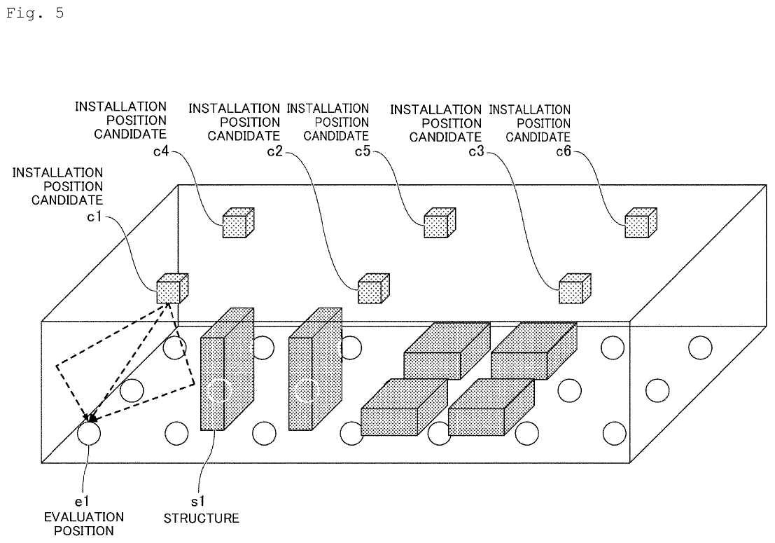

Here, a radio zone design target area will be described with reference to FIG. 5. FIG. 5 is a conceptual diagram of a radio zone design target area. Although an indoor area is described in FIG. 5, an outdoor area may also be used. As illustrated in FIG. 5, within the radio zone design target area, a plurality of installation position candidates cl to c6 at various points on the ceiling, an evaluation position e1 and the like for radio wave quality at various points on the floor, and a structure s1 and the like are set.

The installation position candidates cl to c6 are collectively referred to as “installation position candidate c.” The evaluation position e1 and the like are collectively referred to as “evaluation position e.” Moreover, the structure s1 and the like are collectively referred to as “structure s.” Furthermore, the numbers of installation position candidates c, evaluation positions e, and structures s illustrated in FIG. 5 are merely examples, and are not limited to the numbers illustrated in FIG. 5.

The radio zone design apparatus 30 according to the embodiment selects one or more installation position candidates c that are optimal for a 5G base station from a plurality of installation position candidates c. Furthermore, the radio zone design apparatus 30 may select one or more installation position candidates c that are optimal for a Wi-Fi base station from a plurality of installation position candidates c.

Next, referring back to FIG. 4, the candidate extraction unit 33 estimates the received power (radio wave strength) by performing radio wave propagation estimation (simulation) such as ray tracing using a 3D model. Specifically, the candidate extraction unit 33 estimates the received power at each evaluation position for each combination by performing radio wave propagation estimation for each evaluation position at which 5G radio waves can be received from each base station related to each combination of 5G antennas of a predetermined type when installation is performed in a predetermined installation direction at a predetermined installation position candidate, on the basis of the design environment information and design condition information. Alternatively, the candidate extraction unit 33 estimates the received power at each evaluation position for each combination by performing radio wave propagation estimation for each evaluation position at which Wi-Fi radio waves can be received from a base station related to each combination of AP devices of a predetermined type when installation is performed in a predetermined installation direction at a predetermined installation position candidate, on the basis of the design environment information and design condition information. For example, when there are six installation position candidates on the ceiling, four installation directions, two types of 5G antennas, and 10 evaluation positions on the floor, the candidate extraction unit 33 estimates the received power by performing 480 (=6×4×2×10) calculations. In addition, when there are six installation position candidates on the ceiling, four installation directions, three types of AP devices, and 10 evaluation positions on the floor, the candidate extraction unit 33 estimates the received power by performing 720 (=6×4×3×10) calculations.

When the radio wave propagation estimation unit 32 calculates the throughput instead of the received power, the throughput may be predicted from a conversion table of received power and throughput prepared in advance by acquiring experimental data or by link level simulation, for example.

### <Selection Unit>

The selection unit 35 determines whether there are one or more design result candidates whose design values (device cost and communication quality value) satisfy all of the target values (target value for device cost and target value for communication quality) included in the design target information. That is, the selection unit 35 determines whether there are one or more design result candidates whose design value (device cost) satisfies the target value for the device cost and whose design value (communication quality value) satisfies the target value for the communication quality.

Then, when there are one or more design result candidates that satisfy all of the target values, the selection unit 35 selects the design result candidates that satisfy all of the target values included in the design target information. Then, the selection unit 35 selects, from among the selected design result candidates, specific wireless communication devices that are a predetermined number of top design results having the highest reciprocals of device cost or the highest communication quality values, based on the priority between the target information included in the design target information. For example, in an area where a robot is remotely operated, the communication quality has the highest priority, and the device cost has the second highest priority. In an area where a personal computer (PC) or the like is operated in an office, the device cost has the highest priority, and the communication quality has the second highest priority.

On the other hand, when there is no design result candidate (none at all) whose design value satisfies all of the target values included in the design target information, the selection unit 35 determines whether the design derivation mode included in the design condition information is a cost priority mode, a communication quality priority mode, or a cost and communication quality compatibility mode.

In the case of the cost priority mode, the selection unit 35 calculates each cost evaluation function f_{c}(c(i)) that satisfies the target value for the cost and each communication quality evaluation function f_{q}(q(i)) that indicates the communication quality corresponding to each f_{c}(c(i)), as shown below. Here, cₜ is the target value for the cost, and qₜ is the target value for the communication quality.
Set the cost evaluation function as follows

$${f}_{c} ( c ( i ) ) = 0 ( c ( i ) \leq {c}_{t} )$$

$${f}_{c} ( c ( i ) ) = - ∞ ( c ( i ) > {c}_{t} )$$

Set the communication quality evaluation function as follows

$${f}_{q} ( q ( i ) ) = q ( i ) / {q}_{t}$$

In addition, in the case of the communication quality priority mode, the selection unit 35 calculates each communication quality evaluation function f_{q} (q(i)) that satisfies the target value for the communication quality and each cost evaluation function f_{c}(c(i)) that indicates the cost corresponding to each f_{q}(q(i)), as shown below.
Set the cost evaluation function as follows

$${f}_{c} ( c ( i ) ) = {( c ( i ) / {c}_{t} )}^{- 1}$$

Set the quality evaluation function as follows

$${f}_{q} ( q ( i ) ) = 0 ( q ( i ) \geq {q}_{t} )$$

$${f}_{q} ( q ( i ) ) = - ∞ ( q ( i ) < {q}_{t} )$$

Furthermore, in the case of the cost and communication quality compatibility mode, the selection unit 35 calculates a cost evaluation function f_{c}(c(i)) that increases as the cost decreases, and a communication quality evaluation function f_{q}(q(i)) that increases as the communication quality corresponding to f_{c}(c(i)) increases, as shown below.
Set the cost evaluation function as follows

$${f}_{c} ( c ( i ) ) = {w}_{c} \cdot {( c ( i ) / {c}_{t} )}^{- 1}$$

Set the quality evaluation function as follows

$${f}_{q} ( q ( i ) ) = {w}_{q} \cdot ( q ( i ) / {q}_{t} )$$

(w_{c} and w_{q} are weighting coefficients)
Furthermore, the selection unit 35 calculates each total satisfaction level (Tₛ(i)), and selects a predetermined number of top Tₛ(i) having the highest total satisfaction levels (Tₛ(i)) as design results.

### <Output Unit>

The output unit 37 outputs the final design results. Examples of output include displaying on a display connected to the radio zone design apparatus 30, printing on a printer or the like connected to the radio zone design apparatus 30, or transmitting to the communication terminal 50 via the communication network 100.

### [Processing or Operation of Embodiment]

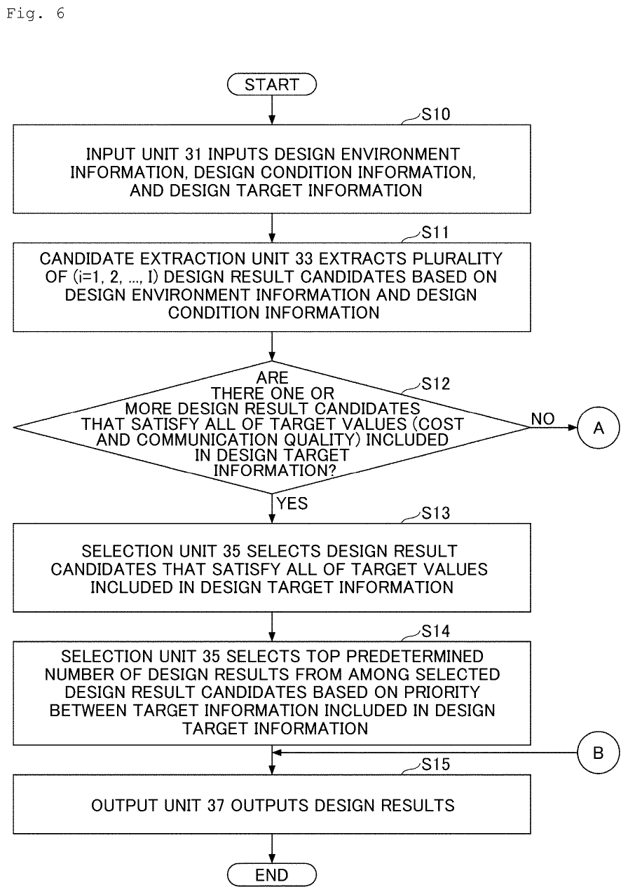

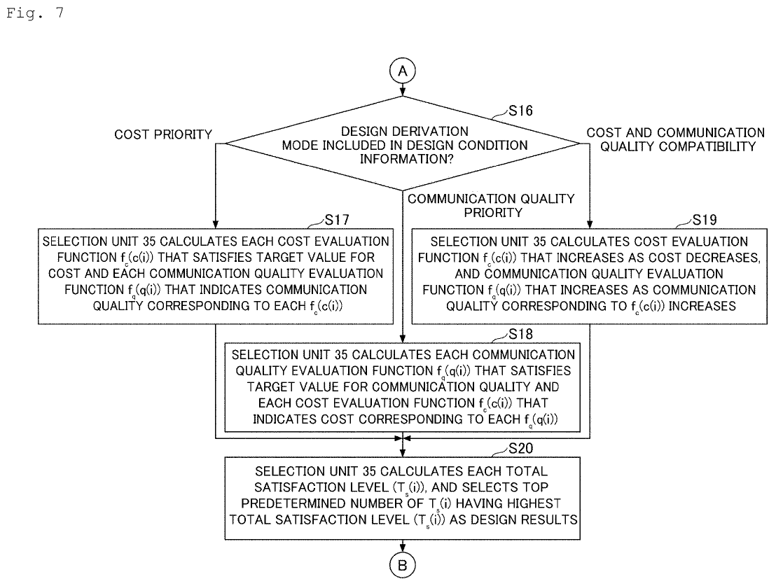

Next, the processing or operation of the radio zone design apparatus 30 will be described with reference to FIGS. 6 and 7. FIGS. 6 and 7 are flowcharts illustrating a radio zone design method executed by the radio zone design apparatus according to the embodiment.
S10: The input unit 31 inputs design environment information, design condition information, and design target information from the communication terminal 50 or the like.
S11: The candidate extraction unit 33 extracts a plurality of (i=1, 2, . . . , I) design result candidates based on the design environment information and the design condition information.
S12: It is determined whether there are one or more design result candidates that satisfy all of the target values (device cost and communication quality) included in the design target information.
S13: When there are one or more design result candidates that satisfy all of the target values (S12: YES), the selection unit 35 selects the design result candidates that satisfy all of the target values included in the design target information.
S14: The selection unit 35 selects, from among the selected design result candidates, a predetermined number of top design results having highest reciprocals of device cost or the highest design values of communication quality based on the priority between the target information included in the design target information.
S16: In process S12, when there is no design result candidate (or none at all) that satisfies all of the target values (S12: NO), the selection unit 35 determines whether the design derivation mode included in the design condition information is a cost priority mode, a communication quality priority mode, or a cost and communication quality compatibility mode.
S17: In the case of the cost priority mode (S16: cost priority), the selection unit 35 calculates each cost evaluation function f_{c}(c(i)) that satisfies the target value for the cost and each communication quality evaluation function f_{q}(q(i)) that indicates the communication quality corresponding to each f_{c}(c(i)). Here, cₜ is the target value for the device cost, and qₜ is the target value for the communication quality.
S18: In the case of the communication quality priority mode (S16: communication quality priority), the selection unit 35 calculates each communication quality evaluation function f_{q}(q(i)) that satisfies the target value for the communication quality and each cost evaluation function f_{c}(c(i)) that indicates the cost corresponding to each f_{q}(q(i)).
S19: In the case of the cost and communication quality compatibility mode (S16: cost and communication quality compatibility), the selection unit 35 calculates a cost evaluation function f_{c}(c(i)) that increases as the cost decreases, and a communication quality evaluation function f_{q}(q(i)) that increases as the communication quality corresponding to f_{c}(c(i)) increases.
S20: After any one of processes S17 to S19, the selection unit 35 calculates each total satisfaction level (Tₛ(i)), and selects a predetermined number of top Tₛ(i) having the highest total satisfaction levels (Tₛ(i)) as design results.

Thereafter, the process proceeds to process S15, and the output unit 37 outputs the final design results.

### [Others]

The above embodiment can also be expressed as follows.

(1) In other words, regarding processes S17 and S20, the selection unit 35 performs a selection process of selecting, from among candidates for a plurality of wireless communication devices to be installed as base stations, a predetermined number of top wireless communication devices having both first design values (for example, device costs or operating costs) satisfying a first target value (for example, is equal to or less than a predetermined value) and considered when performing the design, and the highest second design values (for example, communication quality) considered when performing the design.

(2) In other words, regarding processes S18 and S20, the selection unit 35 is a selection unit included in the radio zone design apparatus, and performs a selection process of selecting, from among candidates for a plurality of wireless communication devices to be installed as base stations, a predetermined number of top wireless communication devices having both first design values (for example, device costs or operating costs) satisfying a first target value (for example, is equal to or less than a predetermined value) and considered when performing the design, and the lowest second design values (for example, device costs or operating costs) considered when performing the design.

(3) In other words, regarding processes S19 and S20, the selection unit 35 performs a selection process of selecting, from among candidates for a plurality of wireless communication devices to be installed as base stations, a predetermined number of top wireless communication devices having the highest sums of a first target value achievement degree (for example, achievement degree equal to or less than a predetermined value) of a first design value (for example, device cost or operating cost) considered when performing the design and a second target value achievement degree (for example, achievement degree equal to or greater than a predetermined value) of a second design value (for example, communication quality) considered when performing the design.

(4) In other words, regarding processes S13 and S14, in the radio zone design apparatus, in a case where there is a wireless communication device whose first design value (for example, device cost or operating cost) satisfies the first target value (for example, is equal to or less than a predetermined value) and whose second design value (for example, communication quality) satisfies a second target value (for example, is equal to or greater than a predetermined value) among the candidates for the plurality of wireless communication devices to be installed as the base stations, the selection unit 35 selects a predetermined number of top wireless communication devices having the lowest first design values or a predetermined number of top wireless communication devices having the highest second design values without performing the selection processes (S17 and S18).

### Effects of Embodiment

As described above, according to the present embodiment, it is possible to provide an effect that appropriate radio zone design can be performed according to the purpose of use.

### [Supplementary Notes]

The present invention is not limited to the above-described embodiment and may have the following configurations or processes (operations).

(1) The radio zone design apparatus 30 can be implemented by a computer and a program, and the program can be recorded in a (non-transitory) recording medium or provided through the communication network 100.

(2) In the above embodiments, the laptop personal computer is shown as one example of the communication terminal 50, but the present invention is not limited thereto, and for example, a desktop personal computer, a tablet terminal, a smartphone, a smartwatch, a car navigation device, a refrigerator, a microwave oven, or the like may be used.

(3) Each of the CPUs 301 and 501 may be not only a single CPU but also a plurality of CPUs.

(4) In each of the above embodiments, the candidate extraction unit 33 estimates the received power at each evaluation position e by radio wave propagation estimation (simulation) such as ray tracing using a 3D model. However, the present invention is not limited thereto. The radio wave propagation estimation unit 32 may, for example, perform actual measurement and prediction of the received power (radio wave strength) by calibrating the radio wave propagation estimation result on the basis of actual measurement data at each evaluation position (a part of the evaluation position).

(5) In addition, the radio zone design apparatus may perform radio zone design for other generations of mobile communication systems, such as 4G and 6G, instead of 5G.

### REFERENCE SIGNS LIST

10 Communication system
30 Radio zone design apparatus
31 Input unit
33 Candidate extraction unit
35 Selection unit
37 Output unit

1. A radio zone design apparatus for performing design related to installation of base stations for wireless communication, the radio zone design apparatus comprising:
a processor; and
a memory storing program instructions that cause the processor to
perform a selection process of selecting, from among candidates for a plurality of wireless communication devices to be installed as the base stations, a predetermined number of top wireless communication devices having both first design values satisfying a first target value and considered when performing the design, and highest second design values considered when performing the design.

2. The radio zone design apparatus according to claim 1, wherein each of the first design values satisfying the first target value indicates a device cost or an operating cost related to a corresponding one of the wireless communication devices being equal to or less than a predetermined value, and each of the second design values indicates a communication quality value of the corresponding one of the wireless communication devices.

3. A radio zone design apparatus that performs design related to installation of base stations for wireless communication, the radio zone design apparatus comprising:
a processor; and
a memory storing program instructions that cause the processor to
perform a selection process of selecting, from among candidates for a plurality of wireless communication devices to be installed as the base stations, a predetermined number of wireless communication devices having both first design values satisfying a first target value and considered when performing the design, and lowest second design values considered when performing the design.

4. The radio zone design apparatus according to claim 3, wherein each of the first design values satisfying the first target value indicates a communication quality value related to a corresponding one of the wireless communication devices being equal to or greater than a predetermined value, and each of the second design values indicates a device cost or an operating cost of the corresponding one of the wireless communication devices.

5. A radio zone design apparatus that performs design related to installation of base stations for wireless communication, the radio zone design apparatus comprising:
a processor; and
a memory storing program instructions that cause the processor to
perform a selection process of selecting, from among candidates for a plurality of wireless communication devices to be installed as the base stations, a predetermined number of wireless communication devices having highest sums of a first target value achievement degree of a first design value considered when performing the design and a second target value achievement degree of a second design value considered when performing the design.

6. The radio zone design apparatus according to claim 1, wherein
in a case where there is a predetermined wireless communication device whose first design value satisfies the first target value and whose second design value satisfies a second target value among the candidates for the plurality of wireless communication devices to be installed as the base stations, the program instructions cause the processor to select a predetermined number of wireless communication devices having lowest first design values or a predetermined number of wireless communication devices having highest second design values without performing the selection process.

7. (canceled)

8. (canceled)
